(19) United States
(12) Patent Application Publication
(10) Pub. No.: US 2025/0101614 A1
(43) Pub. Date: Mar. 27, 2025

(54) SCALABLE ELECTRODE FLOW FIELDS FOR WATER ELECTROLYZERS AND METHOD OF HIGHSPEED MANUFACTURING THE SAME

(71) Applicant: EVOLOH, INC., Palo Alto, CA (US)

(72) Inventors: Jimmy Andrey ROJAS HERRERA, Palo Alto, CA (US); Ashutosh DIVEKAR, Palo Alto, CA (US); Philipp Karl MUSCHER, Palo Alto, CA (US); Scott BLANCHET, Palo Alto, CA (US)

(21) Appl. No.: 18/728,678

(22) PCT Filed: Jan. 5, 2023
(86) PCT No.: PCT/US2023/010194

§ 371 Date: Jul. 12, 2024

Related U.S. Application Data
(60) Provisional application No. 63/299,643, filed on Jan. 14, 2022.

(51) Int. Cl. C25B 11/077; C25B 1/04; C25B 11/031; C25B 11/061; C25B 11/065; C25B 11/081

(52) U.S. Cl. CPC C25B 11/0771; C25B 11/031; C25B 11/061; C25B 11/065; C25B 11/081; C25B 1/04

(57) ABSTRACT

The present disclosure provides approaches for increasing the adhesion of a catalyst ink on a substrate, use of binders within an electrode ink to enhance coating uniformity, incorporating pore-forming agents within an electrode ink, approaches for growing an electrode on a reinforcement layer, increasing the electrochemically active surface area, and incorporation of certain materials in an electrode ink. The present disclosure also relates to electrodes for electrochemical cells, including area-scalable electrodes designed for high-speed manufacturing. The materials, devices and methods described herein may apply to either one or both of an anode or a cathode electrode for an electrochemical cell.

### INCORPORATION BY REFERENCE OF RELATED APPLICATIONS

This application is based upon and claims priority under 35 U.S.C. § 119 (e) to U.S. Provisional Application No. 63/299,643, filed Jan. 14, 2022, the entire contents of which are incorporated herein by reference in their entirety.

### GOVERNMENT SUPPORT

Some embodiments of the subject matter of the present application were made with United States Government support under ARPA-E Award No. DE-AR0001487. The United States Government has certain rights in the subject matter of this application.

### FIELD OF INVENTION

The present disclosure relates to approaches for increasing the adhesion of a catalyst ink on a substrate, use of binders within an electrode ink to enhance coating uniformity, incorporating pore-forming agents within an electrode ink, approaches for growing an electrode on a reinforcement layer, increasing the electrochemically active surface area, and incorporation of certain materials in an electrode ink. The present disclosure also relates to electrodes for electrochemical cells, including area-scalable electrodes designed for high-speed manufacturing. The materials, devices and methods described herein may apply to either one or both of an anode or a cathode electrode for an electrochemical cell.

### BACKGROUND

Electrochemical cells are devices capable of inducing chemical reactions using electricity or generating electricity from chemical reactions. If electricity is the output, the cells may be considered fuel cells or expander cells, depending on the chemical product. If electricity is the input, the cells may be considered electrolyzer cells, compressor cells, or purifier cells, depending on the chemical product. For example, an electrolyzer takes electrical energy and stores it in a fuel such as hydrogen by splitting water into its constituent elements. In contrast, a fuel cell is an electrolyzer running in reverse-hydrogen and oxygen are provided to the cell, which then combines these elements to form water, releasing electrical energy in the process. The basic elements of these devices are two electrodes, an ion-conducting electrolyte, and an ion-permeable layer separating the two electrodes. In the case of solid-electrolytic cells, the ion-conducting electrolyte and separator may be combined into a unitized, solid, ion-conducting membrane. A complete electrochemical cell may also include flow fields for delivering reactants to the electrodes, seals for isolating reactants from each other and the environment and one or more impermeable separator plates, also referred to as bipolar plates, for isolating one cell from adjacent cells in a stack and, in certain embodiments, for containing a separate cooling fluid for thermal management of the cell.

A variety of electrolytes can be used in electrochemical cells, including proton exchange membranes, anion exchange membranes, solid-oxide ceramic membranes, and liquid alkaline solutions such as potassium hydroxide and sodium hydroxide. Different electrolytes demand different operating conditions, and each comes with its own benefits and limitations. Advantages of proton and anion exchange membrane electrolytes may include relatively low operating temperature and a cell that can be constructed using a unitized-layer electrolyte/membrane. Electrolyzers using such membranes have the distinct advantage over other electrolyzer cells of being able to operate using pure, liquid water, rather than a caustic solution or water vapor as a feed stock, thereby greatly simplifying the balance of system in practice.

As society's efforts to address global climate change accelerate, the need for deep decarbonization of all human energy use has become clear and urgent. The use of hydrogen as a carbon-free energy carrier is essential to reaching certain segments of human industry that are difficult or impossible to decarbonize directly with electricity. Examples of such segments include steel production, fertilizer manufacturing, and heavy transport such as trucking, marine, and air vehicles. In addition to these segments, the energy density and stable storage characteristics of hydrogen has made it the most viable candidate for seasonal-scale energy storage and establishment of grid resiliency using only renewable electricity, which will be required for complete conversion of energy use to carbon-free sources. These and other benefits have driven a high level of interest in “green hydrogen” production. Hydrogen is given a “green” label if it is produced by electrolysis from renewable electricity (wind, solar, hydropower, etc.). The scale required to meet the potential demand for green hydrogen in the future global energy system is daunting. Production capacities for electrolyzers will need to increase by many orders of magnitude and their costs reduced by a factor of ten or more over the next decade to meet such demand. Up to now, production of hydrogen electrolyzers has been a niche industry with small systems and limited deployments based on cells and stacks designed for research and development. Only minor considerations have been made for the speed of manufacturing necessary to produce and assemble cells and stacks at a rate commensurate with society's eventual need.

### BRIEF SUMMARY

It is one object of the present disclosure to overcome the limitations of current electrochemical cell design by providing approaches for increasing the adhesion of a catalyst ink on a substrate, use of binders within an electrode ink to enhance coating uniformity, incorporating pore-forming agents within an electrode ink, approaches for growing an electrode on a reinforcement layer, increasing the electrochemically active surface area, and incorporation of certain materials in an electrode ink.

It is another objective of the present disclosure to overcome the limitations of current electrochemical cell design by providing an area-scalable electrode capable of high-speed manufacturing that minimizes capital costs for producing a wide range of electrolyzer cell and stack sizes.

The basic process of water electrolysis involves providing water to a positively charged anode electrode and conducting ions between the anode and a negatively charged cathode electrode. Oxygen is produced at the anode while hydrogen is produced at the cathode. The particular ion employed in this process is a function of the chosen electrolyte. In an acidic cell, positively charged hydronium ions are conducted from the anode to the cathode. In an alkaline cell, negatively charged hydroxide ions are conducted from the cathode to the anode. In both systems, the overall reaction is the same: (2)H₂O (l)→(2)H₂ (g)+O₂ (g). Electricity must be provided to drive the reaction. The open-circuit, or thermo-neutral, voltage for the basic reaction of hydrogen to liquid water is 1.481V, therefore a voltage higher than 1.481V must be applied to a hydrogen electrolysis cell fed with liquid water to cause the reaction to progress. The size (i.e., active area) of the cell determines the rate of hydrogen/oxygen production from one cell at a given applied voltage. The total current required for a particular applied voltage may be proportional to the size (i.e., active area) of the cell. In practical systems, multiple cells may be “stacked” on top of each other to increase production capacity. This stack of cells results in the need to apply a higher voltage (integer multiple of the cell count) to drive the reaction. For example, a single cell of 1000 cm² may produce the same hydrogen flow as two stacked cells of 500 cm², but the 500 cm² stack will require an input of 2× the voltage and 0.5× the current. Flexibility in selecting required voltage and current may be a significant consideration in the design and cost of a total electrolysis system. For example, power supplies for higher current and lower voltage may be more expensive than those for higher voltage and lower current due to the size of the required electrical conductors and additional materials required for their construction.

As the reaction proceeds, water is consumed and hydrogen+oxygen gases are produced, therefore water must be continuously provided to the cell to feed the reaction. Stoichiometry is a term relating to the “balance” of a chemical reaction. In electrochemical cells, the term “stoichiometry” or “stoich” refers to the ratio of reactants fed to a cell relative to the amount required to exactly balance the overall reaction. For example, an electrolysis cell operating at a water stoich of 2 would have as its input twice the amount of water required to produce the hydrogen and oxygen exiting the cell. Conserving mass for the system at 1 stoich shows that 1 kg per hour of hydrogen production is associated with approximately 8 kg per hour of oxygen production and approximately 9 kg per hour of water consumption. Electrolyzers may be typically run with a minimum water stoich greater than 1 to ensure adequate reactants everywhere in the cell. For example, at a water flow stoich of 1, all of the water provided to the cell may be converted to oxygen on the anode, making the oxygen fraction at the cell outlet 100% (i.e. no water exiting the cell). This condition may be unstable and could result in damage due to anode starvation of the cell near the outlet. It may also result in high fluid velocity and pressure loss at the outlet as everything leaving the cell is vapor. Process conditions may therefore be selected to maintain an oxygen vapor fraction at the cell outlet below a given threshold. For example, an outlet oxygen fraction of <40% may result in less than a 2× increase in flow field velocity from water inlet to outlet. To maintain <40% oxygen fraction, a water stoich of up to or greater than 100 may be required.

The electrolysis process is not 100% efficient and as a result some of the input electricity is converted to heat within the cell rather than chemical energy stored as hydrogen. This results in voltages greater than the thermo-neutral voltage (1.481V) being required for practical hydrogen output flow rates. Conserving energy for the system can show that the fraction of electrical power (voltage times current) delivered to the cell that goes into heat may be equal to [1−(1.481/V_{cell})]. A practical electrolysis cell may operate at 1.8V, which results in [1−(1.481/1.8)]=^{˜}18% of the power sent to the cell to turn into heat rather than hydrogen. Therefore, practical electrolysis cells require cooling during operation and an efficient way to accomplish this cooling may be by utilizing the process water itself to cool the cells. Depending on the operating conditions of the cell, a relatively high flow rate of water may be required to ensure the peak temperature of the cell is kept below an acceptable threshold and the temperature gradient within the cell is also acceptable. This flow rate may also represent a water stoich much greater than 1. For example, for a cell operating at 1.8V, releasing 18% of the input energy into heat and operating at 2.7 W/cm², a water stoich of approximately 160 may be required to maintain a temperature rise of <10° C. across the cell. From the design considerations described above, water flow rate into the cell may be determined by the need for adequate reactants or by the need for adequate temperature control, whichever is higher.

Managing the water provided to a hydrogen electrolysis cell/stack may be a major consideration for the overall hydrogen generation system. Flow rate, pressure, temperature and composition must all be regulated to meet the requirements of the cell/stack. A typical system may include a liquid-gas separator, heat exchanger, pump, and de-ionization system connected in a loop with the anode side of the cell/stack to recirculate water at the required flow rate. As the system produces hydrogen and oxygen, one “stoich” of water is consumed. Consumed water may be made-up by injecting 1 stoich of new water into the system loop from a source of acceptable quality (e.g., demineralized, de-salinized, or city water). When considering the scale of an electrolysis plant, the required water flow consumed by the cells/stacks may be proportional to the plant capacity. It may be desirable to keep other process parameters (pressures, temperatures, compositions) uniform regardless of scale as it may greatly simplify system component selection, overall system controls and the cost of engineering, procurement, and construction (EPC) at the deployment site. For example, water pumps may be generally commercially available at a wide range of scale in flow rate for a given pressure capability. It may, therefore, be advantageous to have a basic cell/stack whose water flow resistance is not dependent on cell or stack size. Larger systems could then be constructed in a modular fashion, from more cells and/or more stacks without requiring a change in water pump technology and basic pressure ratings for the system and plant.

### DETAILED DESCRIPTION OF CERTAIN EMBODIMENTS

In one aspect, the present application provides embodiments of a pre-treatment process using adhesion promoters/primer to increase the adhesion of a catalyst ink on a substrate to create a reinforced electrode and to prevent delamination. When discussing adhesion promoters and primers in this application, where technically possible embodiments including one shall also alternatively provide for the other, or include both in combination. In some embodiments the reinforcement substrate is treated with adhesion promoters to improve the surface adhesion of the catalyst inks. These adhesion promoters may include one or more self-assembled monolayers of aliphatic phosphonic acid, silane, alkyl thiols, or similar materials. The adhesion promoter may comprise conductive adhesives such as Electrodag: Bonderite S-FN EB 012 Acheson, Henkel's Loctite® or similar materials. In some embodiments the surface roughness of the electrode reinforcement may be modified by treating with agents that alter the surface tension, such as surfactants (anionic, cationic, zwitterionic), including 3M Fluorosurfactant FC-4430, or similar materials. The adhesion promoters could be in the liquid form and coated directly on the substrate, or they could be deposited using chemical vapor deposition techniques.

The present application also provides embodiments including binders within an electrode ink recipe to enhance coating uniformity and integrity for an electrode. The electrode ink may include one or more non-ionic polymeric binder such as PTFE, PVA, PAA, PVDF, SBR, SEBS, or similar materials. The electrode ink may include ionic polymeric binders containing cationic protons or anionic hydroxide ions. The electrode ink layer may contain surface tension altering agents such as surfactants, fluoro surfactants, silicone surfactants, siloxane, or similar materials. Quaternized poly-vinyl alcohol may be used as an additive binder. The electrode ink layer may contain adhesion promoting agents such as epoxy.

The present application also provides embodiments incorporating pore-forming agents within the electrode ink to promote pore-formation, thereby providing efficient pathways for water to reach the electrode active reaction sites and allowing evolved gases to exit the active reaction sites readily throughout the electrode. The electrode ink may comprise a pore-forming agent which promotes porosity formation in the final reinforced electrode layer. The formed porosity may reduce the mass-transport limitations and promote effective bubble removal for an area-scalable, reinforced anode electrode of the present invention. Pore-forming agents may include one or more of an ammonium bicarbonate, ammonium carbonate, sodium carbonate, sodium bicarbonate, or similar materials. The pore-forming agents may include one or more leavening agents, such as air, steam, yeast, baking soda, baking powder, poly (methyl methacrylate), wheat particles, poppy seeds, saw dust, carbon fibers, graphite or similar materials.

In a preferred embodiment the pore forming agent may comprise ammonium bicarbonate.

The present application also provides embodiments in which the electrode may be grown directly on the reinforcement layer by a treatment procedure such as hydrothermal deposition, electrodeposition, room condition deposition, or a similar process. The electrode layer may contain one or more of platinum, molybdenum, nickel, cobalt, boron, cerium, iron, tin, sulfur, phosphorus, fluorine, oxygen, hydroxide, or similar materials. The electrode may be supported on a conductive support such as carbon (Vulcan, Ketjen black, etc.), nickel, iron, titanium, stainless steel, or combinations of these materials. In a preferred embodiment the electrode comprises iron and nickel in oxide form (NiFe₂O₄) using a nickel foam or nickel felt reinforcement substrate. In another preferred embodiment the electrode comprises Pt and carbon using either a nickel foam, nickel felt or a carbon fiber reinforcement layer.

More specifically, a metallic foam, felt, sintered component, or other porous metallic substrate may be functionalized to serve as an electrode for water electrolyzers and/or fuel cells. This functionalized electrode enables the desired electrochemical reactions in the electrolyzer of fuel cell to occur at high rates and efficiencies, by enabling superior reaction kinetics due to intrinsic catalytic activity and superior conductivity for fluids, electrons, and ions.

In certain embodiments of the present disclosure, the effective electrochemically active surface area (“ECSA”) of a porous substrate may be increased to provide more reaction sites as compared to unmodified substrate, thus increasing the system performance. Thus, in certain embodiments, this is achieved by subjecting a porous (or nonporous) substrate to an alloying step, in which an added or alloyed material reacts with and deposits onto the surface of the porous substrate, such that the atoms of the substrate and the added material are intermixed in the surface region. Subsequently, a dealloying step follows in which the added or alloyed material is removed again. In one example, this may be achieved by alloying stainless steel or nickel with zinc in a liquid zinc bath (galvanizing) for a duration of seconds up to hours, followed by removing the zinc in a potassium hydroxide bath or another medium that dissolves zinc from the alloy. The porous substrate now features a high degree of surface roughness due to the nano- and microscale grooves and voids left behind by the added and later removed material, corresponding to a high effective ECSA. Based on the foregoing, a person of ordinary skill in the art would understand other alloying/dealloying steps are possible depending on the choice of material substrate and alloying materials, and it is intended that the present application encompass such other substrates and alloying materials.

In other embodiments, an increase of ECSA can be achieved by deposition or electrodeposition of a material onto a substrate, without subsequent removal. In other embodiments, an increase of ECSA can be achieved by deposition or electrodeposition of a material onto a substrate, followed by a heat treatment that induces alloying in the material, followed by a dealloying step.

In certain embodiments of the present application, an additional material (such as Pt, Ir, Ni, Fe, Mo, and other materials) is optionally deposited onto the high-ECSA porous substrate described in the preceding paragraphs. This material is inherently—or due to interactions with the substrate material, transformations occurring due to the reaction conditions in the electrolyzer and/or fuel cell, or for other reasons—catalytically active for the desired reaction. In other embodiments, the additional material is not deposited onto the high-ECSA porous substrate but introduced in ionic form into the working fluids of the electrolyzer or fuel cell, such that surface deposition related to the concentration of the additional material in solution determines the surface concentration.

The present application also provides embodiments in which ionomers may be used in the electrode ink formulation. The ionomer may comprise a polymer based on poly (aryl piperidinium) which consists of either a piperidone monomer or a 3-oxo-6-azoniaspiro [5.5]undecane salt monomer, an aromatic and, optionally, a trifluoro acetophenone monomeric group. The ionomer may comprise an ionomer or a polymer based on a styrene-butadiene block copolymer (SEBS) with a tethered quaternary ammonium group through aromatic ring(s). The ionomer may comprise a multiblock copolymer comprising one or more norbornene-based hydrophilic blocks and one or more norbornene-based or alkene-based hydrophobic blocks. The ionomer may comprise a trimethyl or benzyl trimethyl ammonium functionalized polystyrene ionomers with different molar percentages of quaternized benzyl ammonium. The ionomer may comprise of hexamethyl trimethyl ammonium-functionalized Diels-Alder polyphenylene (HTMA-DAPP). The ionomer may comprise an ionomer that uses the tetrakis(dialkylamino)phosphonium cation as a functional group. The ionomer may comprise a polyethylene based triblock copolymer, polychloromethylstyrene-b-polyethylene-b-polychloromethylstyrene (PCMS-b-PE-b-PCMS) quaternized with either trimethyl ammonium or methyl piperidinium cation. The ionomer may comprise an ionomer or polymer comprising a cationic benzimidazolium or imidazolium-containing moieties. The ionomer may comprise an ionomer based on hexamethyl-p-Terphenyl Poly(benzimidazolium). The ionomer may comprise an ionomer or a polymer with a 3M-PFSA (EW 798) precursor containing a copolymer of a tetrafluoroethylene (PTFE) and a trifluoro ethylene functionalized with a perfluorinated sulfonyl fluoride carbon chain. The ionomer may comprise a PPN (polyphenylene) ionomer and/or a PAP (polyaryl piperidinium) ionomer.

In a preferred embodiment, the electrode ink comprises a polymer based on poly (aryl piperidinium) which consists of either a piperidone monomer or a 3-oxo-6-azoniaspiro [5,5]undecane salt monomer, an aromatic and, optionally, a trifluoro acetophenone monomeric group.

In another preferred embodiment, the electrode ink comprises a copolymer comprising one or more norbornene-based hydrophilic monomers and one or more norbornene-based or alkene-based hydrophobic monomers. The polymer could be block co-polymer as well as random co-polymer.

In another preferred embodiment, the electrode ink comprises a polymer based on a styrene-butadiene block copolymer (SEBS) with a tethered quaternary ammonium group through aromatic ring(s).

The present invention provides embodiments in which catalyst materials are used in the electrode formulation. An anode catalyst material may comprise one or more of RuO₂, IrO₂, spinel oxides such as Al_{0.5}Mn_{2.5}O₄, PbRuOₓ, FeₓNi_{y}OOH, IrRuO₂, perovskites, Mo (direct deposited), MoP, IrOₓ/NbOₓ, IrRuO₂/NbOₓ, NiFeCo, NiCe@NiFe/NF, Fe—CoP/NF, Co₃O₄, Co₂O₃, Fe_{0.33}Co_{0.66}P, Fe(PO₃)₂/Ni₂P, (Ni,Fe)OOH, Ni—Fe—OH@Ni₃S₂/NF, Ni(Fe)OₓH_{y}, NiₓFe_{y}, Ni_{y}Fe_{(1-y)}Oₓ, CoₓFe₃₋ₓO₄/CFP wherein x can be (0, 0.1, . . . , 2.0, 2.1, . . . ) and y can be (0, 0.1, . . . , 2.0, 2.1, . . . ). These catalyst materials could also be in the form of nanoparticles or nanowires which may or may not be supported on a conductive support. In some embodiments the anode catalyst may comprise a catalyst promoter such as cerium oxide or a similar material. A cathode catalyst material may comprise one or more of NiₓMo_{y}, Pt/C, Pt alloys/ECS, Pt/ECS, Pt black, Pt alloys, Ni alloys, NiZn, NiMo, MoS₂/Ni₃S₂/NF, a-MoSₓ/CC, Co—Co₂P@NPC/rGO, Ni₂₍₁₋ₓ₎Mi₂ₓP/NF, Co_{2.90}B_{0.73}P_{0.27}/NF, F—Co₂P/Fe₂P/IF, Ni₂P/NF, CoP/Ni₅P₄/COP, P—Fe₃O₄/IF, A-NiCo LDH/NF, where ECS means engineered catalyst support. These catalyst materials could also be in the form of nanoparticles or nanowires which may or may not be supported on a conductive support.

It is to be understood that both the foregoing general descriptions and the following detailed descriptions are exemplary and explanatory only and not restrictive of the disclosure, as claimed.

In yet another embodiment of the present disclosure, a scalable electrode is provided with substantially equal resistance to water flow, equal temperature-rise and equal exit oxygen fraction at a given operating voltage regardless of selected active area. A preferred embodiment of the disclosed electrode may be substantially rectangular, characterized by a dimension along an x-axis selected based on the roll web width (w) of the electrode reinforcement and/or flow field materials used in its production. A desired roll web width (w) may be selected based on maintaining process parameters for the operating electrode within target threshold values. For example, it may be desirable to keep a water pressure drop through the electrode below a pumping pressure limitation of the system, stack, and cell into which the electrode may be installed. Alternately, it may be desirable to keep a water flow temperature rise below a stack, cell, or electrode temperature gradient limitation to ensure acceptable performance and lifetime. Alternately, it may be desirable to keep electrode outlet oxygen volume fraction below a limit that ensures stable performance and lifetime of the cell. Alternately, a desired roll web width (w) may be selected based on available source materials for constructing the electrode reinforcement. For example, it may be desirable to select a roll web width (w) that minimizes scrap material in converting rolls into pieces during assembly. In this case, the desired roll web width (w) for the electrodes and the flow fields may be the same or different. If they are different, the selected roll web width (w) may be chosen based on the most expensive of the electrode reinforcement or the flow fields and the other material rolls may be selected with a web width (w) consistent with the first, where consistent implies a roll web width (w) that optimizes manufacturing speed and/or overall cost.

A variable active area may be achieved from the scalable electrode of the present disclosure by adjusting the length of the anode electrode along a y-axis. Water may then be distributed parallel to a y-axis, along a leading edge of the anode flow field adjacent to the electrode using manifolds, distribution windows, plenums, and/or other in-cell features. A leading edge of an anode flow field may be defined as the edge through which water flows into the flow field. The length the anode flow field along a y-axis may be selected to keep a water velocity along an x-axis at the leading edge of the anode flow field below a predetermined threshold. The overall length of the electrode along a y-axis may then determine the electrode active area and may be selected to achieve an overall target hydrogen production rate for the cell. The y-axis dimension and the flow field thickness may then be selected to maintain water flow pressure loss, water temperature-rise and/or oxygen outlet volume fraction below a target threshold.

The scalable electrode of the present disclosure may comprise one or more electrode reinforcement substrates of a desired roll web width along and x-axis may be selected from the group consisting of a foam, a felt, a woven screen, an expanded metal, and a sintered metal frit. One or more flow field substrates of a desired roll web width along and x-axis may be selected from one or more of a foam, a felt, a woven screen, an expanded metal, or a sintered metal frit. The scalable electrode may also comprise an active electrode material coated, printed, or otherwise attached onto the electrode reinforcement substrate. The scalable electrode may also comprise conversion of the electrode reinforcement substrate to an active electrode material through a chemical, physical or thermal process.

In another embodiment, a method of manufacturing an area-scalable, reinforced electrode is described. An electrode reinforcement substrate of a desired roll web width along and x-axis may be selected from the group consisting of a foam, a felt, a woven screen, an expanded metal, and a sintered metal frit. The electrode reinforcement substrate material from one or more rolls may be directed along a y-axis through calendering rollers configured to achieve the desired thickness and surface properties of each side of the electrode reinforcement substrate and/or to laminate multiple layers together. For example, calendering rollers placed on either side of the substrate web may be of the same diameter or different diameters or they may be of the same material or of different materials. It may be advantageous to use a harder and/or smaller roll on the side of the electrode reinforcement substrate that is to be converted to an active electrode to achieve a denser and/or smoother surface for conversion. It may also be advantageous to use a softer and/or larger roll on the side of the electrode reinforcement substrate that is to be laminated to the flow field substrate to maintain a more porous and/or rougher surface for lamination.

The electrode reinforcement substrate may be converted to an active electrode by an appropriate process. For example, an electrode material may be spray coated, screen printed, rotary screen printed, doctor-blade coated, slot die coated, curtain coated, squeegee coated, or laminated using heat and/or pressure on the appropriate surface of the electrode reinforcement substrate. The electrode conversion process may also include a post-coating step. For example, the coating may be dried, heat treated, annealed, or otherwise physically or chemically processed to promote bonding to the substrate and/or functional performance of the electrode.

A flow field substrate of a desired roll web width along and x-axis may be selected from the group consisting of a foam, a felt, a woven screen, an expanded metal, a sintered metal frit, and combinations thereof. The flow field substrate material from one or more rolls may be directed along a y-axis through calendering rollers configured to achieve the desired thickness, relative density, strength and/or surface properties of flow field and/or to laminate multiple layers of substrate together. For example, calendering rollers placed on either side of the substrate web may be of the same diameter or different diameters or they may be of the same material or of different materials. It may also be advantageous to use a softer and/or larger roll on the side of the flow field substrate that is to be laminated to the electrode reinforcement substrate to maintain a more porous and/or rougher surface for lamination.

These flow fields are usually called porous transport layers or gas diffusion layers. In certain embodiments of the present disclosure, they are made of titanium, aluminum, carbon (e.g., carbon paper, carbon fiber composite, graphite felt, graphene, carbon cloth, etc.), nickel, copper, zinc, stainless steels (e.g., SS 304, SS 316, SS 316L, SS 430, SS A-286, etc.), other materials, or a combination thereof. They may be coated, uncoated, wet-proofed (to increase its hydrophobic properties), and may include a microporous layer (to improve water-repellent properties and improve catalyst adhesion). In some embodiments, the gas diffusion layer has a nanostructure or a microstructure. In some embodiments, the gas diffusion layer is formed of nanowires, microfibers, or cloths. A person of ordinary skill in the art would understand embodiments of the present application may be combined such that they are used together. Further objects, features, and advantages of the present application will become apparent from the detailed description of preferred embodiments which is set forth below, when considered together with the figures of drawing.

### BRIEF DESCRIPTION OF DRAWINGS

The accompanying drawings are incorporated into and constitute a part of this specification. The drawings illustrate certain embodiments only of the present disclosure and, together with the foregoing and following descriptions, explain the principles of the disclosure. Wherever possible the same identification numbers have been used to indicate common or like components across different figures.

FIG. 1 shows an isometric view of electrolysis cell components of FIG. 3 illustrating exemplary cross flow orientation of the process fluids along x- and y-axes and the repeating of cell components along a z-axis to create a stack of cells.

FIG. 2 shows a cross-section of electrolysis cell components in the active area of a typical cell illustrating ion, electron and fluid flows for proton and anion exchange membrane electrolysis technologies.

FIG. 3 shows an isometric view of an anode flow field component illustrating trade-offs present in scaling the cell active area.

FIG. 4 shows mathematical model output for pressure loss through an exemplary flow field for water and hydrogen flow versus velocity and an illustrative pressure loss target threshold.

FIG. 5 shows test results for water flow resistance for a variety of flow field candidates, confirming the model results of FIG. 4 for water flow pressure loss and illustrating alternate illustrative pressure loss target thresholds.

FIG. 6 shows mathematical model output for water temperature rise versus water stoich value for two exemplary cell operating voltage values and an illustrative water temperature rise threshold.

FIG. 7 shows mathematical model output for oxygen volume fraction at the outlet versus water stoich value for an exemplary cell operating pressure and an illustrative oxygen volume fraction threshold.

FIG. 8 shows multiple test results for mechanical strength of a candidate flow field, illustrating the percentage of initial thickness the material must be calendered to in order to withstand a target compressive loading when assembled into a complete cell/stack.

FIG. 9 shows the basic steps that may be included in a high-speed manufacturing process for creating a scalable, reinforced electrode and an integrated electrode flow field component.

FIG. 10 shows a plan view of the process of FIG. 9 illustrating the inherent y-axis scalability (I) of the reinforced electrode and flow field component manufacturing processes from a fixed, x-axis roll web width (w) to achieve cells of variable active area.

FIG. 11 shows some illustrative examples of embossing or patterning of surfaces of an electrode and/or flow field substrate to promote bonding during lamination.

FIG. 12 shows a representative scanning electron microscope image of an anode electrode synthesized using pore forming agents presently disclosed.

FIG. 13 shows measured performance data over time for a preferred embodiment of the present invention illustrating superior lifetime compared to prior art.

### DETAILED DESCRIPTION OF DRAWINGS

Detailed descriptions of the figures of drawing will now be given with reference to the accompanying drawings. Although the following descriptions relate primarily to electrolysis, it is understood that the described features, components, and methods are applicable and adaptable, by those skilled in the art, to other electrochemical technologies including hydrogen compressors, hydrogen purifiers, CO₂ electrolyzers, chlorine electrolyzers, etc. One of ordinary skill would understand the subject matter described in the foregoing embodiments (relating to, e.g., approaches for increasing the adhesion of a catalyst ink on a substrate, use of binders within an electrode ink to enhance coating uniformity, incorporating pore-forming agents within an electrode ink, approaches for growing an electrode on a reinforcement layer, increasing the electrochemically active surface area, and incorporation of certain materials in an electrode ink) may be applied to the embodiments set forth in the figures of drawing.

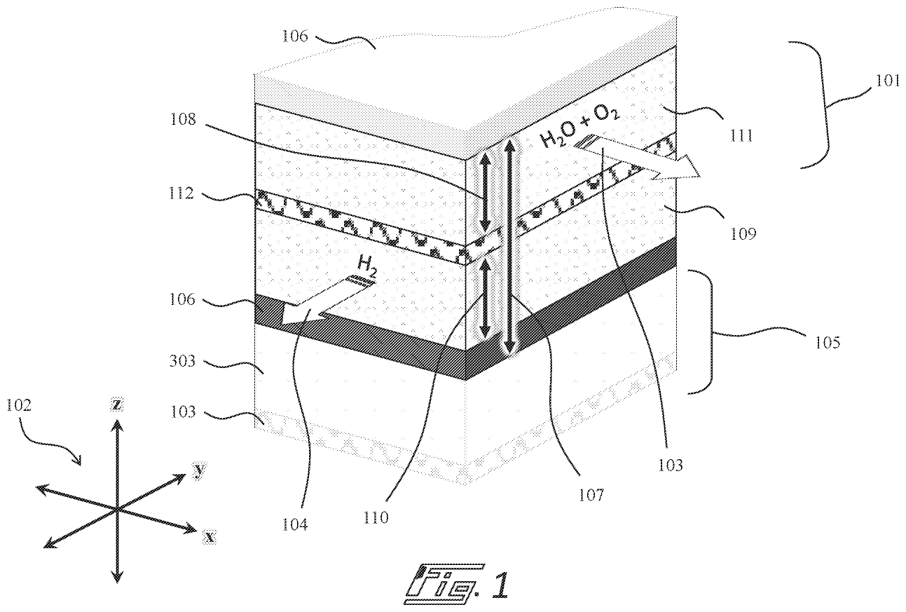

FIG. 1 shows an isometric view (101) of an electrolyzer illustrating exemplary cross flow orientation (103) and (104) of the process fluids and the repeating of cell components (105) along a z-axis (102) to create a stack of cells. Here, the bipolar plate (106) can be seen separating one cell of thickness (107) from an adjacent cell (105). Water and oxygen (103) may flow along an x-axis in the combined anode electrode flow field (111) of thickness (108). Hydrogen (104) may flow along a y-axis in the combined cathode electrode flow field (109) of thickness (110). Assuming the cell is oriented as shown with a gravity vector downward and parallel to the z-axis, it may be advantageous to position the anode above the membrane as shown to allow buoyancy to assist in moving oxygen bubbles that form on the anode electrode into the water flowing through the anode flow field above the anode electrode.

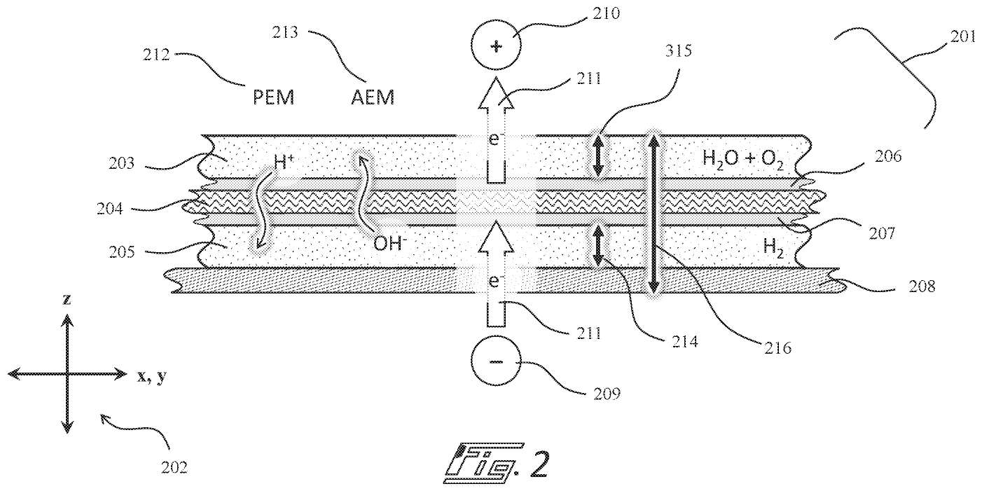

FIG. 2 shows a cross-section of exemplary core electrolysis cell components (201) in the active area of a cell, illustrating typical ion, electron, and fluid flows for proton (212) and anion (213) exchange membrane electrolysis technologies. Here (208) is an impermeable separator, or bipolar, plate; (205) is a cathode flow field; (207) is a cathode electrode; (204) is an ion-conducting membrane; (206) is an anode electrode and (203) is an anode flow field. Attaching a power supply to the cell with a negative pole (209) at the bottom and a positive pole (210) at the top, may cause electrons (211) to flow upward through the cell. If the cell is an acidic, proton-conducting type (212), positive hydronium ions may be motivated by the resulting electrical field to move downward through the membrane (204). If the cell is an alkaline, hydroxide-conducting type (213), negative hydroxide ions may be motivated by the resulting electrical field to move upward through the membrane (204). In both types, hydrogen may be formed on the cathode (207) and flow into the cathode flow field (205), whereas oxygen may be formed on the anode (206) and flow into the anode flow field (203). In dry-cathode systems, water may be provided only to the anode flow field (203) as a reactant for forming hydrogen and oxygen. Stoichiometry is a term relating to the “balance” of a chemical reaction. In electrochemical cells, the term “stoichiometry” or “stoich” refers to the ratio of reactants fed to a cell relative to the amount required to exactly balance the overall reaction. As described earlier in this specification, the water stoich provided to anode flow field (203) may be much higher than 1. Also, because the fluid in the anode flow field (203) may be mostly liquid, this compartment may represent significant flow resistance compared to the cathode flow field. The thickness of the cathode (214) and anode (215) flow fields may have an impact on flow velocity, temperature distribution and pressure losses in the cell. The overall cell pitch (216) of the cell may be determined by the thicknesses of each of components (203) through (208) making up the complete cell. A small cell pitch (216) may be desirable for producing an electrolyzer stack with high power density and a small size for a given hydrogen production rate [kg/hr]. Therefore, optimizing the anode flow field geometry—length in a water flow direction along an x-axis, width along a y-axis and thickness along a z-axis—may be a critical design goal for an electrolyzer. For example, anode (203) and/or cathode (205) flow fields may be configured with thicknesses of 0.1 to 5.0 mm, 0.2 to 3.0 mm, 0.3 to 2 mm, 0.5 to 2 mm or 0.6 to 2 mm. Flow fields (203) and (205) may be selected with the same or different thicknesses based on factors for optimizing cell process conditions, performance and manufacturing.

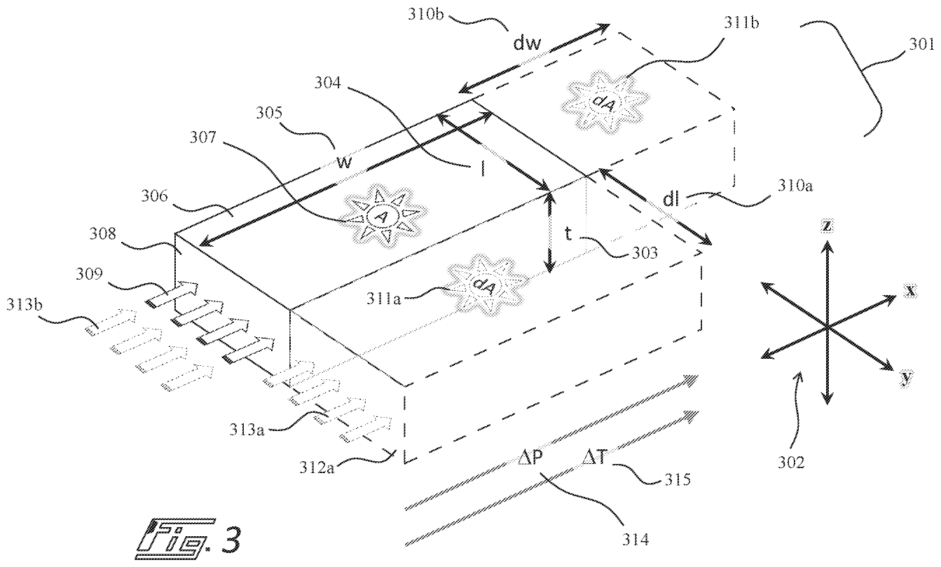

FIG. 3 shows an isometric view (301) of an anode electrode flow field component (306) illustrating the trade-offs that may be present in scaling the cell area. An anode flow field may comprise a width “w” (305) along an x-axis, a length “I” (304) along a y-axis and a thickness “t” (303) along a z-axis. A width “w” (305) along an x-axis may be between 5 and 1000 cm, between 5 and 500 cm, between 5 and 100 cm, or between 10 and 50 cm. A length “I” (304) along a y-axis may be between 1 and 5000 cm, between 5 and 3000 cm, between 10 and 1000 cm or between 25 and 1000 cm. The active area (307) may be found by multiplying the width “w” (305) by the length “I” (304). A water flow area at a leading edge (308) may be found by multiplying the thickness “t” (303) by the length “I” (304). A water flow for a fixed stoich and efficiency (309) into this water flow area (308) may be determined by the area (307). To achieve higher hydrogen production [kg/hr] at a fixed efficiency and water stoich may require added area “dA” (311a) and/or (311b). If “dA” (311b) is made by adding “dw” (310b) to “w” (305), added water (313b) may be required to flow into the fixed leading edge flow area (308). The added water flow may thereby increase water flow velocity through the flow field and may result in increased pressure drop (314). If “dA” (311a) is made by adding “dl” (310a) to “I” (304), added water (313a) may be accompanied by a proportional increase in fixed leading edge flow area (312a). The added water may flow through the incremental and proportional flow area (312a) without increasing pressure drop (314). Therefore, scaling area along a y-axis may allow all process conditions-pressures, temperatures, and oxygen volume fraction-within the electrode to remain constant. While total water flow rate may necessarily be proportional to hydrogen/oxygen production rate, other system parameters may be unchanged by scaling the electrode along only a y-axis. This may greatly simplify the resulting electrolyzer systems made from electrodes designed in this way. For example, electrolyzer production plant specifications including pressure ratings, temperature ratings, and/or fluid composition ratings may be consistent for plants of different water flow and hydrogen/oxygen capacities. This, in turn may simplify engineering procurement and construction activities, expand available supplies of system components, and reduce overall hydrogen production costs.

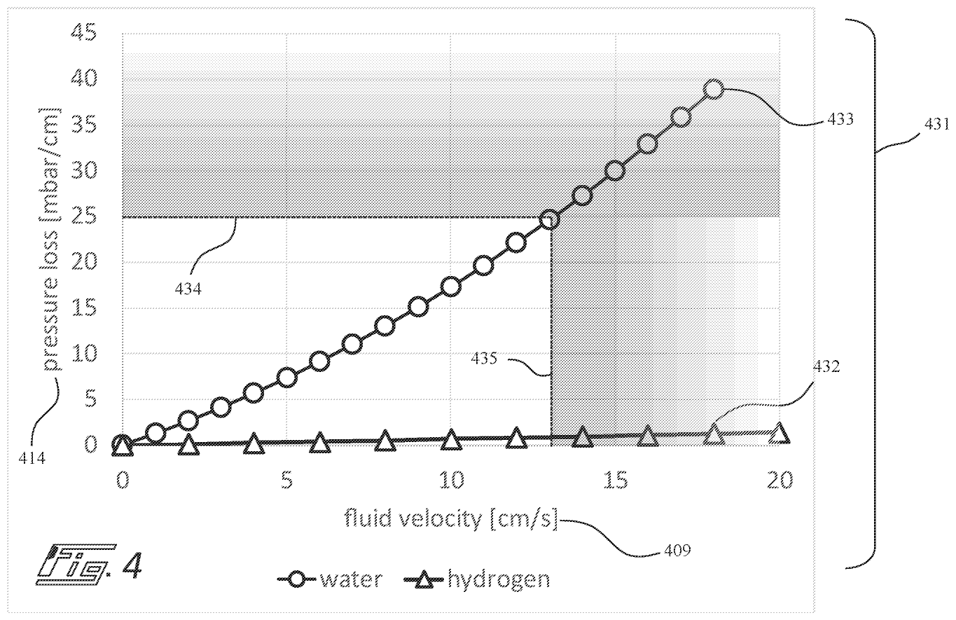

FIG. 4 shows mathematical model results (431) for pressure loss per unit flow length (414) [mbar/cm] as a function of flow velocity (409) [cm/s] for a hydrogen gas (432) and a liquid water (433) flowing through a typical porous media that may be used for an anode and/or cathode flow field. Also shown is an illustrative target pressure loss threshold (434) that may selected based on the overall electrolyzer stack and system design. Threshold (434) may represent an upper limit for water pressure loss and thereby define a target threshold for water velocity in the anode flow field (435). As evident from results (431), pressure loss per unit length for hydrogen may be several times less than for water at a given velocity. It may, therefore, be advantageous to prioritize electrode scaling based on water velocity and flow length as cell area increases. For example, water pumps for delivering water to an electrolysis cell may have pressure capability of up to 10 bar. It may be advantageous to configure anode flow field (401) to enable water velocity (409) below 100 cm/s, below 50 cm/s, below 20 cm/s, below 10 cm/s or below 5 cm/s to stay within the capabilities of commonly available system water pumps.

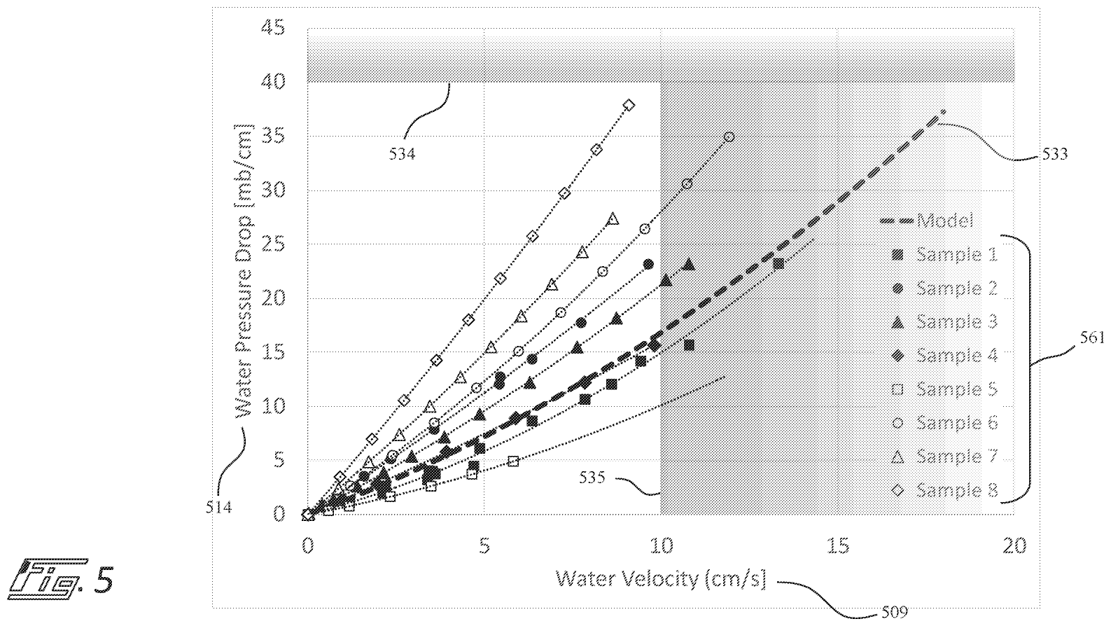

FIG. 5 shows test results (561) for pressure loss per unit flow length (514) [mbar/cm] as a function of flow velocity (509) [cm/s] for liquid water flowing through a number of porous media candidates that may be used for an anode and/or cathode flow field. The mathematical model results from FIG. 4 (533) are repeated for reference along with an illustrative target pressure loss threshold (534) that may selected based on the overall electrolyzer stack and system design. Threshold (534) may represent an upper limit for water pressure loss and thereby define a target threshold for water velocity in the anode flow field (535) for these real potential flow field candidates (samples 1 through 8).

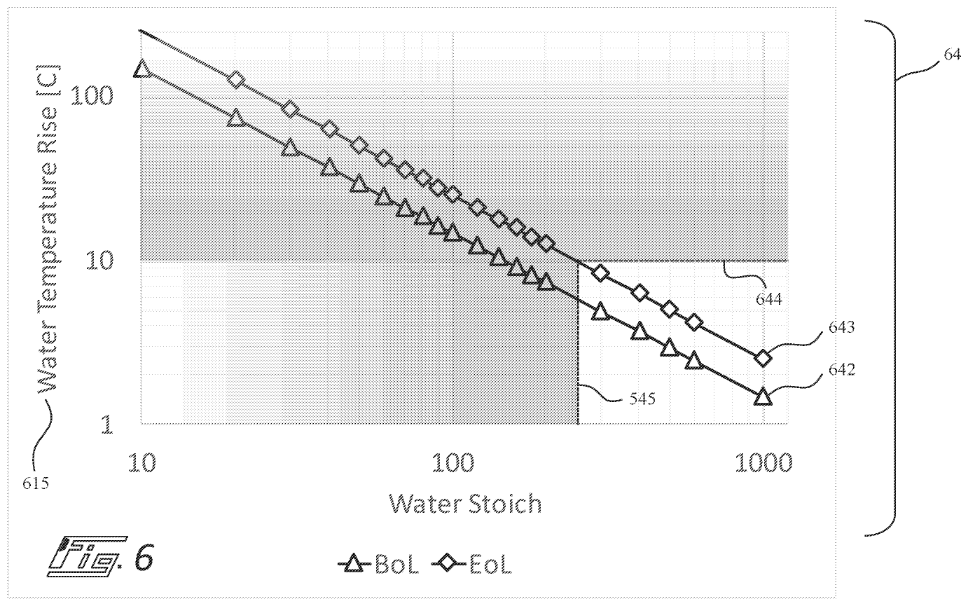

FIG. 6 shows mathematical model results (641) for water temperature rise (615) [° C.] as a function of delivered water stoich value. Heat released during electrolyzer operation may be a function of efficiency, which in turn, may be a function of operating cell voltage. Conserving energy for a cell may result in a formula for water temperature rise as specified in equation 6c-1 (below). Here V is the cell voltage, V₀ is the thermo-neutral cell voltage [1.25V], LHV is the lower heating value of hydrogen [120 MJ/kg], cₚ is the specific heat capacity of water [4.182 KJ/kg° C.] and St is the water stoich delivered to the cell. Plots (642) and (643) show results of this model at two possible operating voltages representing exemplary values for beginning [BoL] and end [EoL] of life for an electrolysis cell. Also shown is an illustrative water temperature rise target threshold (644), above which an anode electrode may not operate stably or durably or above which an electrolysis cell, stack or system may not operate efficiently. The temperature rise threshold may be used with an EoL voltage limit to define a lower threshold for water stoich (645). It may be advantageous to select a water stoich to maintain a water temperature rise at end of life below 100 C, below 50 C, below 25 C, below 15 C or below 10 C to maintain stable and durable operation of the electrode.

$$Δ T = \frac{( \frac{V}{{V}_{0}} - 1 ) \cdot LHV}{9 {c}_{p} \cdot St} \qquad Equation 6 c - 1$$

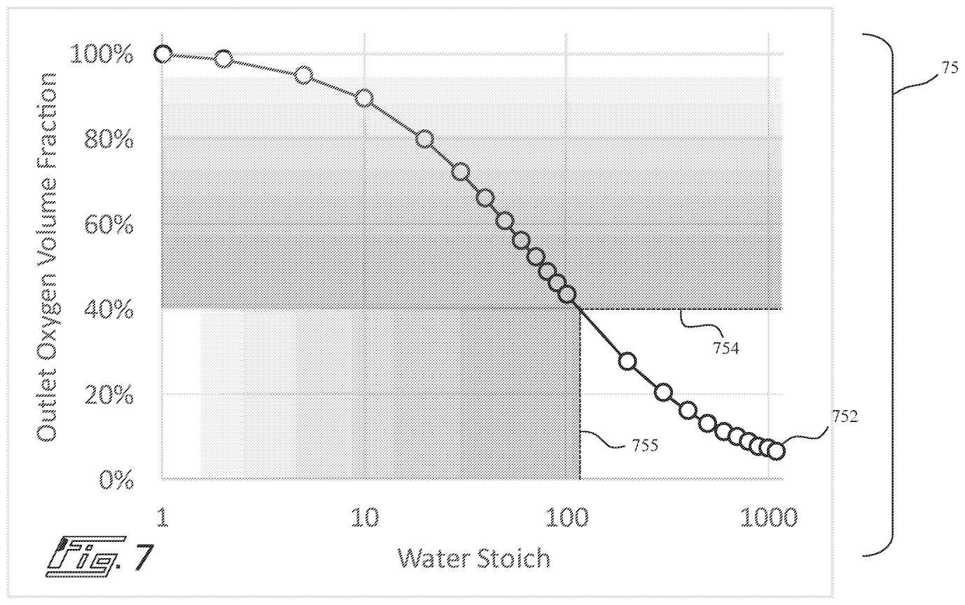

FIG. 7 shows mathematical model results (751) for oxygen volume fraction at the anode flow field outlet (752) as a function of delivered water stoich value. The process of electrolysis splits water into hydrogen, on the cathode side, and oxygen, on the anode side. As oxygen forms on the anode, it may mix as a gas with the delivered liquid water, resulting in a two-phase flow in the anode flow field. The volume fraction of oxygen at the anode outlet may be indicative of operating stability, performance and/or durability of the electrode and a target threshold for this parameter may be set by a designer. Conserving mass for a cell may result in a formula for oxygen outlet volume fraction as specified in equation 7d-1. Here ρ_{O2} is the density of the oxygen gas at the anode outlet, ρ_{H2O} is the density of the liquid water at the anode outlet and St is the water stoich delivered to the cell. Plot (752) shows the results of this model at 10 bara pressure for an anode electrode along with an illustrative oxygen volume fraction threshold (754), above which the electrode may not operate stably or durably or above which an electrolysis cell, stack or system may not operate efficiently. The oxygen volume fraction threshold may be used to specify a lower threshold for water stoich (755). It may be advantageous to select a water stoich to maintain an oxygen volume fraction below 80%, below 60%, below 50%, below 40% or below 30% in order to maintain stable and durable operation of the electrode.

$${f}_{O 2} = \frac{1}{1 + \frac{9 {ρ}_{O 2}}{8 {ρ}_{H 2 O}} \cdot ( St - 1 )} \qquad Equation 7 d - 1$$

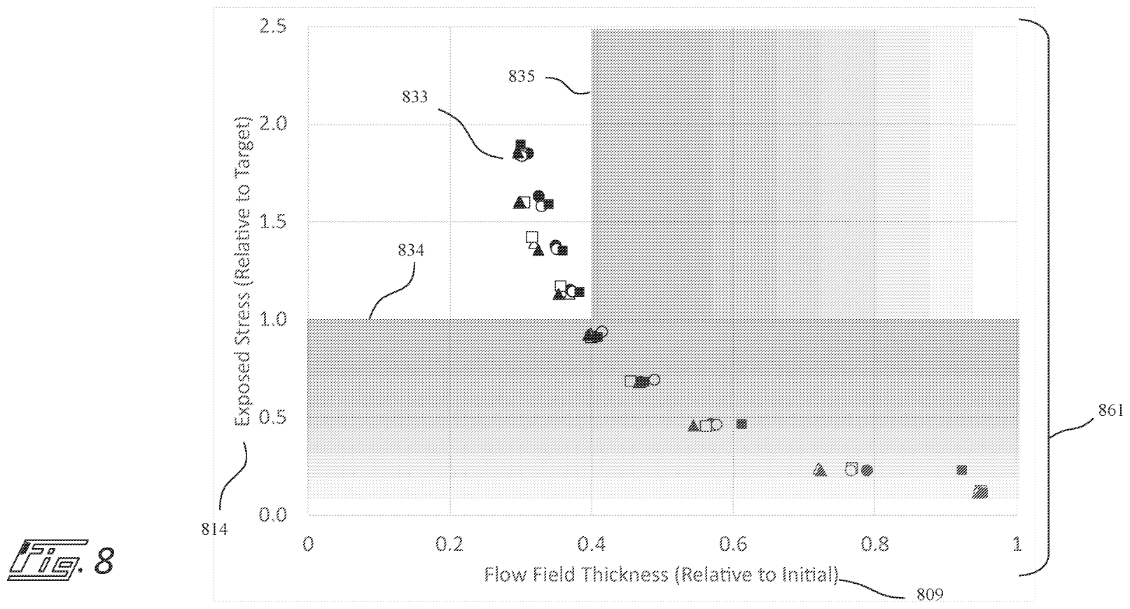

FIG. 8 shows measured strength data (861) for several samples of candidate electrode reinforcement materials illustrating the permanent change in thickness (809) as a function of the mechanical exposure stress (814). This curve then represents the material yield strength as a function of deformed thickness. During assembly of the electrolysis stack, compressive load will be applied to the active area in order to maintain adequate contact and low contact resistance between the layers in a cell and between individual cells in the stack. The applied compressive load at assembly may be greater than the expected internal fluid pressure of the stack to ensure that cells or cell components do not separate during operation. It is desirable to maintain elastic behavior of the cells and cell components to ensure this contact is maintained. As illustrated by limits (834) and (835), it may then be advantageous to permanently deform the electrode reinforcement materials to a value less than X % of their initial thickness to ensure the electrode reinforcement remains elastic. For the candidate materials tested X=40%, but the specific value for any candidate electrode reinforcement material may be greater or less than 40% based on the particular characteristics and material properties of the candidate including porosity, basis weight—defined as the mass per unit area in an x-y plane—material of construction, and porous geometry (e.g. foam, mesh, expanded metal, felt or other).

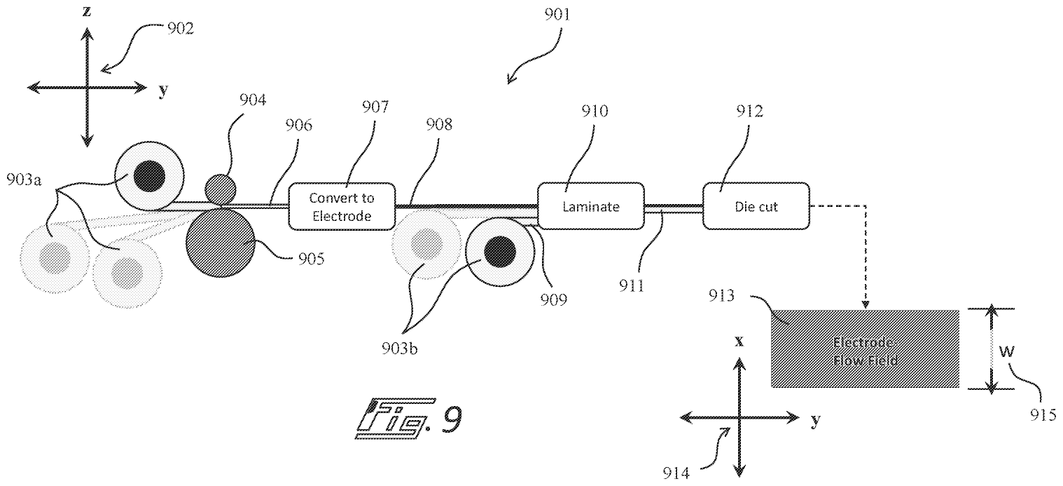

FIG. 9 shows the basic steps in a high-speed manufacturing process (901) for creating an reinforced electrode and flow field component (913). One or more rolls of porous substrate (903a) may be selected based on a desired roll web width “w” (915) as previously described. The substrate may comprise a foam, a felt, a woven screen, an expanded metal, a sintered frit or a fiber cloth or paper. The selected substrate may have a porosity of up to 98% where porosity is defined as the volume percent of the substrate available to through-flow of fluid. For example, the porosity may be between 98% and 40%, between 95% and 50%, between 90% and 60%, or between 95% and 80%. The composition of the substrate may comprise iron, nickel, chromium, steel, stainless steel, Inconel, aluminum, titanium, carbon, or combinations of these. The substrate may be plated or coated with other materials such as platinum, gold, tin, carbon, titanium nitride, PTFE or another corrosion-inhibiting layer including engineered layers of polymeric or oxide materials with conductive metal or carbon pathways. The roll(s) (903a) may be loaded onto an unwinding station designed to hold the web flat, under a known tension and able to move along a y-axis (902). The roll(s) (903a) may be calendered through a set of rollers (904) and (905) to laminate more than one layer together, reduce the porosity of the web, reduce or increase its thickness, increase its strength, increase its stiffness, and/or create desired surface characteristics on one or both sides of the web (906). For example, it may be advantageous for the substrate to be relatively smooth on one side and rough on the other to facilitate steps later in the process. It may also be advantageous to achieve a porosity gradient through the thickness of the substrate. For example, it may be beneficial to downstream processes to have one side of calendered substrate (906) be relatively low porosity for accepting a conversion to an electrode while having the opposite side of (906) be relatively high porosity to promote bonding with a second substrate. To achieve different propertied on each side of web (906), the rollers (904) and (905) may be the same or different diameter and/or be made of the same or different materials and/or be constructed with different surface finishes or coatings and/or be provided with specific surface patterns that may be embossed onto one or both sides of roll web (903a). The calendered, reinforcement substrate (906) may then be converted to an electrode (908) in process (907) as set forth in the embodiments described in the present disclosure. For example, an electrode material may be spray coated, screen printed, rotary screen printed, doctor-blade coated, slot-die coated, curtain coated, squeegee coated or laminated as a film, decal or solid layer using heat and/or pressure on the appropriate surface of the electrode substrate (906). The electrode conversion process (907) may also comprise a post-coating step. For example, the coating may be dried, heat treated, annealed and/or otherwise physically or chemically treated to promote bonding to the substrate and/or electrochemical performance of the cell. The conversion process (907) may also comprise a chemical or physical vapor deposition process for conversion to an active electrode (908). The conversion process (907) may also comprise a plasma or flame spray process for depositing electrode material onto the substrate (906) or for chemically reacting and/or converting (906) into an active electrode. Following process (907), electrode web (908) may be placed adjacent to one or more additional rolls of porous substrate (903b). These substrates may be identical to or different from electrode substrates (903a) and may be selected based on a similar range of possible materials and propertied as (903a), but toward meeting functional requirements for a fluid flow field, rather than an electrode reinforcement. For example, it may result in the highest purchase volume and lowest supply cost to make (903b) identical to (903a). It may be advantageous for cell performance—electrical resistance, flow resistance, thermal conductivity, mechanical resiliency, or mechanical strength—to select (903b) from a different substrate than (903a). In process step (910) the electrode web (908) may be laminated to flow field web (909) through an appropriate lamination process. The lamination process (910) may comprise mechanical rolling or calendering through rollers similar to (904) and (905) in order to promote co-penetration of solid fibers, ligaments or wires from web (908) with web (909). To accomplish this mechanical bonding, the similar rollers (904) and (905) may be the same or different diameter and/or be made of the same or different materials and/or be constructed with different surface finishes or coatings and/or be provided with specific surface patterns. It may be advantageous to select (903a) and (903b) from the same supplied material, but to pre-calender and/or laminate multiple layers of (903b) before lamination step (910). The pre-calendering/laminating step may include embossing a pattern into the side of (909) to be co-penetrated with (908) to promote mechanical bonding. The laminating process (910) may also comprise other steps including heat treatment or application of bonding promoters such as adhesives, polymer suspensions, liquid ionomers, or ionomer suspensions to one or more of the webs (908) and (909). The order of steps (907) and (910) may be reversed so that conversion of web (906) to electrode (908) may take place after laminating to web (909). It may be advantageous for certain electrode materials and/or methods to be formed only after calendering and laminating to ensure adequate adhesion is maintained in the final web (911). In some cases, the electrode may be coated onto the membrane, in which case the conversion step (907) may be skipped in process (901). Following lamination step (910), the unitized electrode flow field web (911) may be processed (912) to create discreet piece parts (913) of the appropriate size for integration into an electrolysis cell (915). For example, the web (911) may be processed in step (912) by stamping with a knife or other cutting die to ensure precise sizing of the piece parts. In some cases, laminating web (908) to web (909) may take place after cutting step (912). The exact size of parts (913) may depend on whether an anode or a cathode electrode flow field is to be produced. The overall process (901) may be adapted as necessary to produce either anode or cathode electrode/flow fields and specific materials, coatings, steps, and settings of the line may be the same or different for each. In production, two independent lines may be employed to simultaneously produce one anode and one cathode electrode/flow field to enable high-speed manufacturing of complete electrolysis cells.

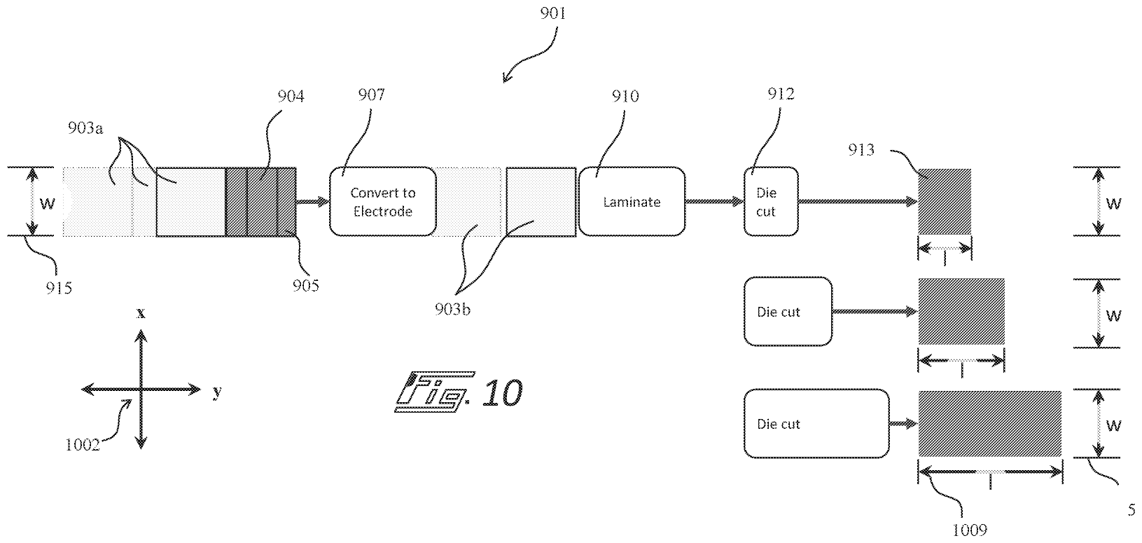

FIG. 10 shows a plan view (x-y plane) of the process described in FIG. 9. Descriptive labels have been kept the same between the figures. The area-scalability of the present invention is illustrated by variable length die cut steps (912) resulting in variable area electrode piece parts (913) by changing only the length (1009) of the parts. Process (901) has the advantage of requiring capital equipment of a fixed roll handling width (915) to produce electrodes of varying active area while achieving consistent operating conditions for the various size electrodes, as described in FIGS. 3 through 7.

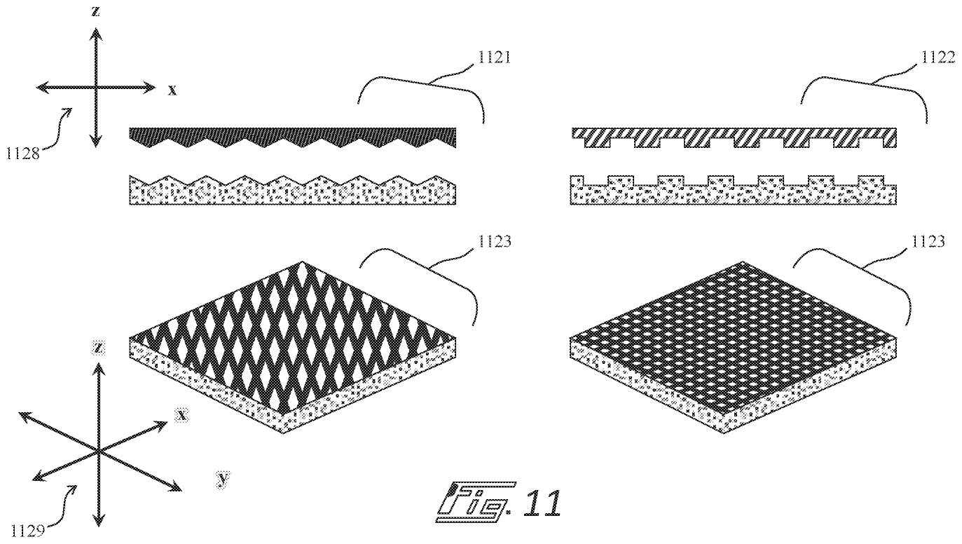

FIG. 11 shows several illustrative examples of patterning or embossing of an electrode and/or flow field substrate to promote enhanced bonding during lamination steps of process (901). Patterns may be linear, along a y-axis as shown in (1121) and (1122), along an x-axis (not shown) or along both x- and y-axes in a crosshatch style (1123) and (1124). The profile shape—triangle (1121), rectangle (1122) or other shapes (not shown)—depth and spacing may be optimized based on the material and other properties of the substrates to be laminated.

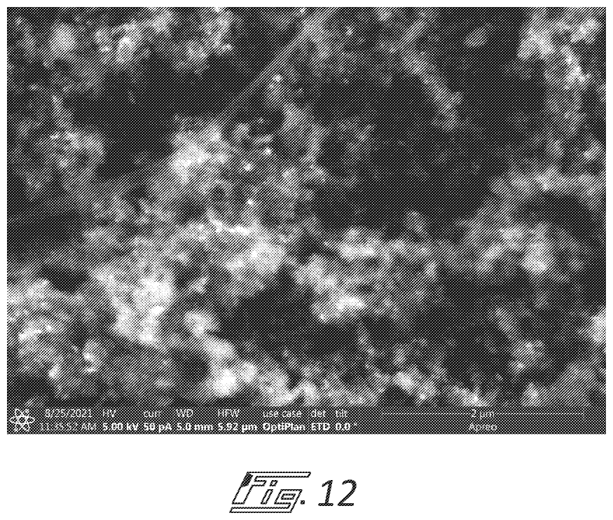

FIG. 12 shows an electron scanning microscope image taken of an electrode synthesized per a preferred embodiment of the present invention using a bicarbonate pore forming agent illustrating the resulting macro- and micro-porosity of the electrode structure.

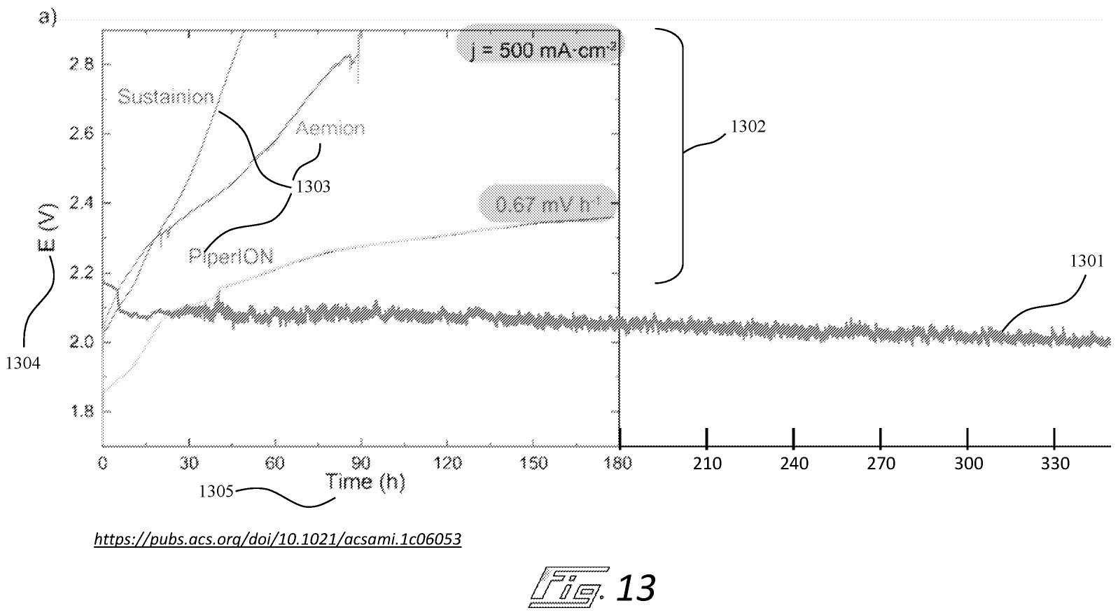

FIG. 13 shows performance data (1301) of cell voltage (1304) as a function of operating time (1305) measured on a cell operating at 0.5 A/cm² and 60° C., with a NiFe₂O₄ anode electrode synthesized and fabricated on a nickel foam reinforcement layer per a preferred embodiment of the present invention. The data illustrate over 330 hours of durable operation without catalyst detachment or washout. For comparison, public data (1302) [ACS Appl. Mater. Interfaces 2021, 13, 44, 51917-51924, https://pubs.acs.org/doi/10.1021/acsami.1c06053] is overlayed, illustrating greater decay rate and inferior lifetime for 3 competitive systems (1303) at comparable operating conditions as compared to the present invention (1301).

### Further Embodiments

A-1. An electrode for an electrochemical cell, comprising:
   an active electrode material,
   a reinforcement substrate, and
   a flow field,
   wherein the open flow field comprises a first layer comprising a material selected from the group consisting of a foam, a felt, a woven screen, an expanded metal, and a sintered metal frit of a desired roll web width along an x-axis,
   wherein the reinforcement substrate comprises a second layer comprising a material selected from the group consisting of a foam, a felt, a woven screen, an expanded metal, and a sintered metal frit of a desired roll web width along an x-axis,
   wherein a thickness of the flow field along a z-axis and a length of the flow field along a y-axis are independently adjustable to produce a variable cell active area that maintains a water flow resistance, a water temperature rise, or a cell outlet oxygen volume fraction below a target threshold for the electrode.
A-2. The electrode of A-1,
   wherein the thickness and length are selected to achieve a water flow velocity less than 100 cm/s at a leading edge of the flow field or wherein the thickness and length are selected to achieve a water flow pressure drop less than 5 bar between a leading edge and a training edge of the flow field when operated at rated conditions and hydrogen production capacity.
A-3. The electrode of A-1 to A-2,
   wherein the open flow field comprises a multilayer laminate.
A-4. The electrode of A-1 to A-3,
   wherein a thickness of the combined reinforced electrode and flow field is less than 3 mm, preferably 2 mm, most preferably 1 mm.
A-5. The electrode of claim A-1 to A-4,
   wherein a water temperature rise is less than 50° C.
A-6. The electrode of claim A-1 to A-5,
   wherein the outlet oxygen volume fraction is less than 95%.
A-7. The electrode of A-1 to A-6,
   wherein the active electrode material is bonded to the reinforcement substrate an adhesion promoter selected from the group consisting of an adhesive, a polymer dispersion, a liquid ionomer, an ionomer dispersion, and mixtures thereof.
A-8. The electrode of A-1 to A-7,
   wherein the bonding promoter is PTFE incorporated into the electrode ink during synthesis.
A-9. The electrode of A-1 to A-8,
   wherein the active electrode material contains a forming agent selected from the group consisting of ammonium bicarbonate, ammonium carbonate, sodium carbonate, sodium bicarbonate, air, steam, yeast, baking soda, baking powder, and mixtures thereof.
A-10. The electrode of A-1 to A-9,
   wherein the active electrode material and the flow field comprise at least one of carbon, nickel, titanium, iron, chromium, stainless steel, or Inconel.
A-11. The electrode of A-1 to A-10,
   wherein the electrode reinforcement substrate and the flow field comprise one or more nickel foam layers.
A-12. The electrode of A-1 to A-11,
   wherein a porosity, basis weight, number of layers, and final laminated thickness of the flow field are selected to prevent yielding during assembly, compression, and operation of the cell.
A-13. The electrode of claim A-1 to A-12,
   wherein the yield strength achieved is greater than 5 kgf/cm², preferably 10 kgf/cm², more preferably 15 kgf/cm², and most preferably 25 kgf/cm².
A-14. The electrode of claim A-1 to A-13,
   wherein one or more of the electrode reinforcement substrate and flow field substrate comprises a rough, patterned, or embossed surface to promote lamination.
B-1. A method of manufacturing an integrated electrode flow field for a scalable electrolysis cell comprising:
   forming an open flow field through lamination or calendering to a desired thickness along a z-axis one or more layers selected from the group consisting of a foam, a felt, a woven screen, an expanded metal, and a sintered metal frit of a desired roll web width along an x-axis;
   cutting the open flow field web into discrete pieces corresponding to a desired length along a y-axis;
   forming an electrode reinforcement substrate through lamination and/or calendering to a desired thickness along a z-axis one or more layers selected from the group consisting of a foam, a felt, a woven screen, an expanded metal, and a sintered metal frit of a desired roll web width along an x-axis;
   converting the formed electrode reinforcement substrate to an active, reinforced electrode;
   cutting the active reinforced electrode web into discrete pieces of a desired length along a y-axis; and
   placing the open flow field and active, reinforced electrode components adjacent to each other such that the resulting assembly achieves a desired cell active area while maintaining one or more of a water flow resistance or a water temperature rise or a cell outlet oxygen volume fraction below a target threshold for the electrode.
B-2. The method of B-1,
   wherein the thickness and length are selected to achieve a water flow velocity less than 100 cm/s at the leading edge of the flow field.
B-3. The method of B-1 to B-2,
   wherein the thickness and length are selected to achieve a water flow pressure drop less than 5 bar between the leading and training edges of the electrode flow field when operated at rated conditions and hydrogen production capacity.
B-4. The method of B-1 to B-3,
   wherein a thickness of the combined reinforced electrode and flow field is less than 3 mm, preferably 2 mm, most preferably 1 mm.
B-5. The method of B-1 to B-4,
   wherein the water temperature rise is less than 50° C.
B-6. The method of B-1 to B-5,
   wherein the outlet oxygen volume fraction is less than 95%.
B-7. The method of B-1 to B-6,
   wherein the flow field web and reinforced electrode web are laminated prior to cutting into discrete piece parts.
B-8. The method of B-1 to B-7,
   wherein electrode and flow field substrates comprise at least one of carbon, nickel, titanium, iron, chromium, stainless steel or Inconel.
B-9. The method of B-1 to B-8,
   wherein one or more of the reinforced electrode web and flow field web is processed to produce a rough, patterned, or embossed surface to promote lamination.
B-10. The method of B-1 to B-9,
   wherein the laminating step includes a bonding promoter selected from the group consisting of an adhesive, a polymer dispersion, a liquid ionomer, and an ionomer dispersion.
B-11. The method of B-1 to B-10,
   wherein the electrode reinforcement substrate comprises one or more nickel foam layers having a basis weight between 100 g/m² and 1000 g/m².
B-12. The method of B-1 to B-11,
   wherein the electrode conversion of the electrode reinforcement substrate occurs before lamination to the flow field web.
B-13. The method of B-1 to B-12,
   wherein the electrode conversion of the electrode reinforcement substrate occurs after lamination to the flow field web.
B-14. The method of B-1 to B-13,
   wherein the reinforced electrode and flow field are laminated upon assembly within the electrolysis cell.
B-15. The method of B-1 to B-14,
   wherein a porosity, basis weight, number of layers and final laminated thickness of the flow field are selected to prevent yielding during assembly, compression, and operation of the cell.
B-16. The method of B-1 to B-15,
   wherein the yield strength is greater than 5 kgf/cm², preferably 10 kgf/cm², more preferably 15 kgf/cm², most preferably 25 kgf/cm².
C-1. A method of increasing the effective electrochemically active surface area of a substrate, comprising
   alloying a substrate with an alloy material, wherein the alloy material is incorporated into the surface of the substrate,
   subsequently de-alloying the substrate to remove the alloy material; or
C-2. The method of C-1,
   wherein the substrate is porous.
C-3. A method of increasing the effective electrochemically active surface area of a substrate, comprising
   deposition or electrodeposition of a material onto a substrate, such that the added material creates a higher surface roughness.
C-4. The method of C-3,
   further comprising applying heat treatment to induce alloying of the material and subsequently de-alloying the substrate to remove the alloy material.
C-5. The method of C-1 to C-4,
   further comprising depositing or electrodepositing an additional catalytic material onto the substrate.
C-6. The method of C-1 to C-5,
   further comprising introducing an ionic material in a working fluid that deposits on the electrochemically active surface area and increases the catalytic activity of the surface.
D-1. A method for increasing adhesion of a catalyst ink on a substrate, comprising:
   treating the substrate with an adhesion promoter, wherein the adhesion promoters is selected from the group consisting of (a) self-assembled monolayers of aliphatic phosphonic acid, silane, alkyl thiols, or similar materials, (b) conductive adhesives such as Electrodag: Bonderite S-FN EB 012 Acheson, or similar materials, and (c) mixtures thereof.
D-2. The method of D-1,
   further comprising modifying the surface roughness of the substrate, wherein the surface roughness is modified by treating the surface with agents that alter the surface tension, such as surfactants, including 3M Fluorosurfactant FC-4430, or similar materials.
D-3. The method of D-1 to D-2,
   wherein the substrate is an electrode.
E-1. An electrode ink for coating an electrode, comprising:
   a binder or a pore forming agent.
E-2. The electrode ink of E-1,
   wherein the binder is selected from the group consisting of PTFE, PVA, PAA, PVDF, SBR, SEBS, and similar materials.
E-3. The electrode ink of E-1 to E-2,
   wherein the binder is an ionic polymeric binder containing cationic protons or anionic hydroxide ions.
E-4. The electrode ink of E-1 to E-3,
   further comprising a surface tension altering agent, wherein the surface tension altering agent is selected from the group consisting of surfactants, fluoro surfactants, silicone surfactants, siloxane, and similar materials.
E-5. The electrode ink of E-1 to E-4,
   further comprising quaternized poly-vinyl alcohol.
E-6. The electrode ink of E-1 to E-5,
   wherein the pore forming agent is selected from the group consisting of an ammonium bicarbonate, ammonium carbonate, sodium carbonate, sodium bicarbonate, similar materials, and mixtures thereof.
E-7. The electrode ink of E-1 to E-6,
   wherein the pore forming agent is a leavening agents, wherein the leavening agent is selected from the group consisting of air, steam, yeast, baking soda, baking powder, similar materials, and mixtures thereof.
F-1. A method of producing an electrode, comprising:
   growing the electrode on a reinforcement layer via hydrothermal deposition, electrodeposition, room condition deposition, or a similar process.
F-2. The method of F-1,
   wherein the electrode comprises platinum, molybdenum, nickel, cobalt, boron, cerium, iron, tin, sulfur, phosphorus, fluorine, oxygen, hydroxide, similar materials, or mixtures thereof.
F-3. The method of F-1 to F-2,
   wherein the electrode is supported on a conductive support, wherein the conductive support comprises such as carbon (Vulcan, Ketjen black, etc.), nickel, iron, titanium, stainless steel, or combinations of these materials.
F-4. The method of F-1 to F-3,
   wherein the electrode comprises a nickel iron oxide (NiFe₂O₄),
   wherein the reinforcement layer comprises a nickel foam or nickel felt.
F-5. The method of any of F-1 to F-4,
   wherein the electrode comprises Pt and carbon,
   wherein the reinforcement layer comprises a nickel foam, nickel felt, or a carbon fiber reinforcement layer.

The foregoing description has been presented for purposes of illustration and description only. It is not intended to be exhaustive or to limit the application to the precise form disclosed, and modifications and variations are possible and/or would be apparent in light of the above teachings or may be acquired from practice of the application. The embodiments were chosen and described in order to explain the principles of the application and its practical application to enable one skilled in the art to utilize the application in various embodiments and with various modifications as are suited to the particular use contemplated. It is intended that the scope of any issued patent be defined by the claims appended hereto.

1. A method of increasing the effective electrochemically active surface area of a substrate, comprising:
(a) alloying a substrate with an alloy material, wherein the alloy material is incorporated into the surface of the substrate,
subsequently de-alloying the substrate to remove the alloy material; or
(b) deposition or electrodeposition of a material onto a substrate, such that the added material creates a higher surface roughness.

2. The method of claim 1,
wherein the substrate is porous.

3. The method of claim 1,
wherein after (b), further comprising applying heat treatment to induce alloying of the material and subsequently de-alloying the substrate to remove the alloy material.

4. The method of claim 1,
further comprising depositing or electrodepositing an additional catalytic material onto the substrate.

5. The method of claim 1,
further comprising introducing an ionic material in a working fluid that deposits on the electrochemically active surface area and increases the catalytic activity of the surface.

6. A method for increasing adhesion of a catalyst ink on a substrate, comprising:
treating the substrate with an adhesion promoter, wherein the adhesion promoters is selected from the group consisting of (a) self-assembled monolayers of aliphatic phosphonic acid, silane, alkyl thiols, or similar materials, (b) conductive adhesives such as Electrodag: Bonderite S-FN EB 012 Acheson, or similar materials, and (c) mixtures thereof.

7. The method of claim 6,
further comprising modifying the surface roughness of the substrate, wherein the surface roughness is modified by treating the surface with agents that alter the surface tension, such as surfactants, including 3M Fluorosurfactant FC-4430, or similar materials.

8. The method of claim 6,
wherein the substrate is an electrode.

9. An electrode ink for coating an electrode, comprising:
a binder or a pore forming agent.

10. The electrode ink of claim 9,
wherein the binder is selected from the group consisting of PTFE, PVA, PAA, PVDF, SBR, SEBS, and similar materials.

11. The electrode ink of claim 10,
wherein the binder is an ionic polymeric binder containing cationic protons or anionic hydroxide ions.

12. The electrode ink of claim 9,
further comprising a surface tension altering agent, wherein the surface tension altering agent is selected from the group consisting of surfactants, fluoro surfactants, silicone surfactants, siloxane, and similar materials.

13. The electrode ink of claim 9,
further comprising quaternized poly-vinyl alcohol.

14. The electrode ink of claim 9, wherein the pore forming agent is selected from the group consisting of an ammonium bicarbonate, ammonium carbonate, sodium carbonate, sodium bicarbonate, similar materials, and mixtures thereof.

15. The electrode ink of claim 9,
wherein the pore forming agent is a leavening agents, wherein the leavening agent is selected from the group consisting of air, steam, yeast, baking soda, baking powder, similar materials, and mixtures thereof.

16. A method of producing an electrode, comprising:
growing the electrode on a reinforcement layer via hydrothermal deposition, electrodeposition, room condition deposition, or a similar process.

17. The method of claim 16,
wherein the electrode comprises platinum, molybdenum, nickel, cobalt, boron, cerium, iron, tin, sulfur, phosphorus, fluorine, oxygen, hydroxide, similar materials, or mixtures thereof.

18. The method of claim 16,
wherein the electrode is supported on a conductive support, wherein the conductive support comprises such as carbon (Vulcan, Ketjen black, etc.), nickel, iron, titanium, stainless steel, or combinations of these materials.

19. The method of claim 16,
wherein the electrode comprises a nickel iron oxide (NiFe₂O₄),
wherein the reinforcement layer comprises a nickel foam or nickel felt.

20. The method of claim 16,
wherein the electrode comprises Pt and carbon,
wherein the reinforcement layer comprises a nickel foam, nickel felt, or a carbon fiber reinforcement layer.
